(19) United States
(12) Patent Application Publication
(10) Pub. No.: US 2005/0108596 A1
(43) Pub. Date: May 19, 2005

(54) Method of verifying circuitry used for testing a new logic component prior to the first release of the component

(76) Inventor: Craig F. Deaton, Sachse, TX (US)

Correspondence Address: TEXAS INSTRUMENTS INCORPORATED, P O BOX 655474, M/S 3999, DALLAS, TX, 75265, US

(21) Appl. No.: 10/949,041

(22) Filed: Sep. 24, 2004

Related U.S. Application Data
(60) Provisional application No. 60/505,853, filed on Sep. 25, 2003.

(51) Int. Cl. G06F 11/00

(52) U.S. Cl. 714/41

(57) ABSTRACT

A method and operation for developing and testing the logic environment used for providing logic inputs to and receiving logic inputs from a logic device or device under test such as an ASIC device prior to the completion of the device production design. The invention eliminates much of the waiting time typically required for determining whether problems are due to design errors in the DUT or incorrect operation of the environment used to test and develop the DUT.

This application claims the benefit of U.S. Provisional Application No. 60/505,853, filed on Sep. 25, 2003, entitled A METHODOLOGY FOR ACCELERATING NEW PRODUCT DEVELOPMENT, which application is hereby incorporated herein by reference.

### TECHNICAL FIELD

The present invention relates to the development and testing of new complex semiconductor products such as ASIC's (Application Specific Integrated Circuit) or other logic components, and more specifically for testing the “correctness” of the logic or verification environment before the product or device (DUT) is released and available for testing.

### BACKGROUND

Presently available basic products and other complex semiconductor devices often include several millions or more individual logic circuits that must be tested or proven before released for sale and/or distribution. However, in addition to checking the operation of the product or component, it is also necessary to test or verify the correctness of the component operational environment. That is, does the verification environment that provides inputs to the new developed component and receives output from the new component function properly? Unfortunately, it is difficult or substantially impossible to have confidence that the logic or verification environment is functioning properly without having a component or product known to be operating properly that can be tested, evaluated, and “passed” by the environment verification circuitry. On the other hand, it is impossible to fully test or verify the component or product unless the logic environment is known to be functioning properly. That is, the product or component, hereinafter referred to as a device under test (DUT), debugging must be substantially complete before the verification environment debugging can proceed. Yet, acceptable debugging of the component or DUT can only be accomplished by a properly operating verification environment.

When new ASIC's or logic devices had significantly fewer circuits and functions, this “chicken or the egg” inter-relationship problem could be handled by relatively few testing iterations that only required reasonably acceptable testing delays. However, now with millions and millions of circuits to be tested on a single device, such a “start-stop and then correct the problem approach regardless of whether the problem was in the environmental or in the device” has become exponentially more complex and is simply unacceptable and too costly.

Presently available techniques to solve this problem require an independent design effort to generate independent models of the components, products or DUT's (Device Under Test). The actual logical component or DUT is typically implemented in an HDL (Hardware Design Language) such as VHDL or Verilog. However, to provide greater flexibility, a general purpose programming language such as “C” is preferably used to implement the independent model of the component. This independent design effort to generate the model is separate from the design and development of both the component or DUT and the verification environment. This traditional solution is both complex, time consuming, and of course expensive. Consequently, it is not unusual to skip testing of the environment circuitry and simply assume that the verification environment is correct. This risky approach may end up being more costly and time consuming than the traditional approach discussed above.

Therefore, it would be very advantageous to effectively test and prove the verification environment well prior to the final develop of the device or product.

### SUMMARY OF THE INVENTION

A method and apparatus for developing and testing for correct and accurate operation of the testing environment used for verifying the proper operation of a complex logical component or device under test (DUT) is disclosed. The development and testing of the environment for correct operation may be completed before the development of the component or DUT is complete. The invention comprises a “virtual” component or DUT representative of the actual component or DUT. The virtual DUT or component receives logic inputs and provides logic outputs. For example, inputs, or signals representative of selected typical logic inputs that would be provided to the actual component or DUT in a final product are generated by the environment or verification circuitry. The “generated” inputs are selected to cause variations or changes in various outputs of the DUT in the same manner as if such inputs were provided to an operational DUT. Thus, the invention also includes verification or environmental testing circuitry for monitoring both the logic inputs and the logic outputs of the DUT.

The environmental or verification circuitry further includes circuitry for predicting or determining what the logic output (or the logic inputs) of the selected component, device or DUT should be when selected inputs (or outputs) are provided. That is, the logic outputs are a function of the logic inputs. This also means, of course, that the logic inputs can be determined as a function of the logic outputs. There is also included circuitry for driving the logic outputs and logic inputs of the virtual device or component to values that are the same as the predicted logic outputs and/or inputs. The driven logic outputs/inputs are then compared to the predicted logic outputs/inputs to determine if they really are the same. The various logic components that are used in the virtual DUT device are, where possible, the same as the logic components used in the verification environment.

The logical or verification environment is further tested and refined by injecting selected errors, such as input logic errors, internal device errors, and output logic errors to ascertain that the monitored logic outputs change or respond to the injected errors.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1A is a block diagram of a prior art verification environment for testing newly developed logic components or devices such as ASIC's;

FIG. 1B illustrates the developmental timeline using the prior art verification environment of FIG. 1A;

FIG. 2 is a block diagram of a prior art solution for verification of a testing environment using an “Independent Reference Design” DUT;

FIG. 3 is a block diagram illustrating the use of a virtual DUT (Device Under Test) in a verification environment according to the teachings of the present invention;

FIG. 4 is a block diagram illustrating another embodiment of the invention wherein logic outputs responses of the virtual DUT are driven to agree with predicted logic outputs;

FIG. 5 is a block diagram illustrating another embodiment of the invention similar to that of FIG. 4 and further including circuitry for injecting errors into the DUT and the verification environment; and

FIG. 6 illustrates a developmental timeline of a DUT using the verification environment of the present invention.

### DETAILED DESCRIPTION OF ILLUSTRATIVE EMBODIMENTS

Apparatus and method embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

As was discussed above, because of the ever increasing complexity of IC designs, it has become necessary to develop effective and efficient automated verification environments. A known stable and dependable verification environment is critical in verifying the component or DUT (Device Under Test) if the verification or testing results carried out on the DUT is to have any credibility. Unfortunately, however, with complex components or devices and presently available technology, the verification environment cannot be considered fully stable and dependable for testing a device until it has been tested and verified as operating properly. On the other hand, this environment testing cannot be fully completed until there is a functional and properly operating device available for testing. Furthermore, evaluation of the verification environment cannot even start until the device is sufficient developed to release the RTL (Register Transfer Language) version of this device. Consequently, completion of the verification environment and debugging of the RTL version is delayed as problems in the test code are discovered and repaired.

It will also be understood by those skilled in the art, that although the final product or device such as an ASIC sold to the public is a semiconductor device, most of the actual verification or testing of a new product design is accomplished in software. Therefore, even though the present invention may be described and discussed as though the logic device (DUT) and logic environment is hardware or dedicated circuitry, the invention is preferably implemented in software.

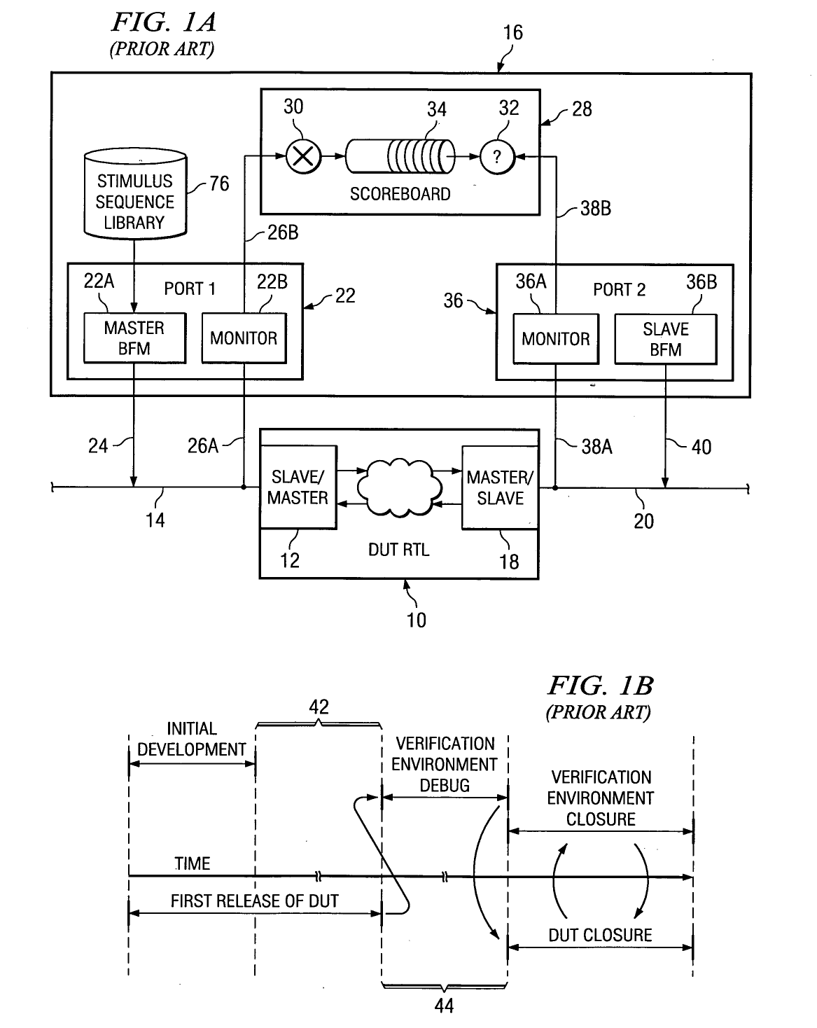

Referring now to FIG. 1A there is illustrated a block diagram of a DUT being tested in a prior art verification environment. As shown, there is included a component or DUT (Device Under Test) 10 based on and coded with the RTL (Register Transfer Language). The component or DUT 10 includes a “slave” component in input portion 12 that receives inputs or commands on signal lines 14 from the verification environment circuitry 16. DUT 10 also includes a “master” component in output portion 18 that provides outputs or commands on signal lines 20 to the verification environment circuitry 16. As will be discussed hereinafter, and as is often the case, the input portion 12 will also include a “master” component as well as the “slave” component, and the output portion 14 will also include a “slave” component as well as the “master” component. For example, after the “slave” component of the input portion 12 receives the “address” of a logic input on line 14 the “handshake” protocol typically requires an “acknowledgement” provided by a “master” component of the input portion 12. Likewise, after the master component of output portion 18 provides a logic output (or command) on line 20 to a slave component in the verification environment 16, an acknowledgement is typically provided by a “master” component in verification environment 16 on signal line 20 to a “slave component” in the output portion 18.

Therefore as shown, DUT 10 is connected to the verification environment 16 by signal lines 14 and signal lines 20. The verification environment or circuitry 16 typically will include first port circuitry 22 for providing logic or functional signals representative of or models of (i.e. BFM or bus functional model signals) “input” logic signals from “master” component 22a on signal line 24 and then to input lines 14 where they are transmitted to the slave component of input portion 12 of DUT 10. The logic input signals are typically generated by suitable circuitry such as a Stimulus Sequence Library 76. “Logic input” signals inserted on lines 14 are also monitored by monitor line 26a and monitor circuitry 22b to verify the accuracy of the applied logic input.

The parameters of this monitored “input logic” signal are then provided by monitor circuitry 22b to Scoreboard Circuitry 28 by line 26b. Scoreboard Circuitry 28 includes prediction circuitry or predictor 30, a comparing circuitry or comparator 32, and the register or array circuitry 32 used to store the predictions from predictor 30.

A second port circuitry 36 connected to output line 20 also includes monitor circuitry 36a and a line connection 38a for monitoring various “logic outputs” on lines 20. As discussed above, the handshake acknowledgement signal is provided from the output of second port circuitry 36 to output lines 20 by signal line 40 and then to the slave component of output portion 18.

Referring again to the Scoreboard Circuitry 28, monitor circuitry 36a then provides the parameters of the “logic output” signals received from DUT 10 to a second input of comparator 32 by signal line 38b. Therefore, comparator 32 can compare the monitored logic output on lines 20 to the parameters of the predicted logic output stored in array 34. If the two signals are the same, then according to the prior art arrangement, it is presumed that the tested circuit in the DUT is operating correctly. Unfortunately as will be discussed below, if the verification circuitry has not itself been verified, or in many situations where there are many complex circuits, an indication of a correct reading by the comparator 32 may actually be incorrect or meaningless.

The problem is that as the ASIC's or DUT's increase in complexity, the verification environment will also become more and more complex. This means that the debugging effort for the verification circuitry is likewise more complex and requires substantial effort. For example, and as mentioned above, until there is confidence that the verification circuitry will indicate that a properly operating DUT is, in fact, operating properly and will also indicate when an improperly operating DUT is, in fact, operating improperly, there can be no confidence in an indication of correct operation of the DUT as indicated by the received logic outputs. On the other hand, until there is a device available that is known to be operating properly, and that can undergo testing by the verification environment, it is extremely difficult to validate that the verification environment or test circuitry is itself operating properly. For very simple circuits this dependent inter-relationship can be handled by a series of test iterations. Unfortunately, if the device to be tested includes millions and millions of logic circuits, the start test, stop test, debug, start test again process is simply unacceptable and too time consuming.

FIG. 1B illustrates the unacceptable component or DUT development and verification development timeline according to the prior art. The top portion of FIG. 1B represents the environmental development, and the bottom portion of FIG. 1B represents the component or DUT development. As shown, the verification engineer wastes time waiting on the first release of the DUT as indicated at 42 due to bugs or design problems in the device, and the device or circuit engineer wastes time waiting as indicated at 44 due to bugs or design problems in the verification environment. This wasted time adds unnecessarily to the total development time and these delays may be very costly in lost sales and market opportunities. Therefore, methods and apparatus that help eliminate such lost and wasted time would be very advantageous.

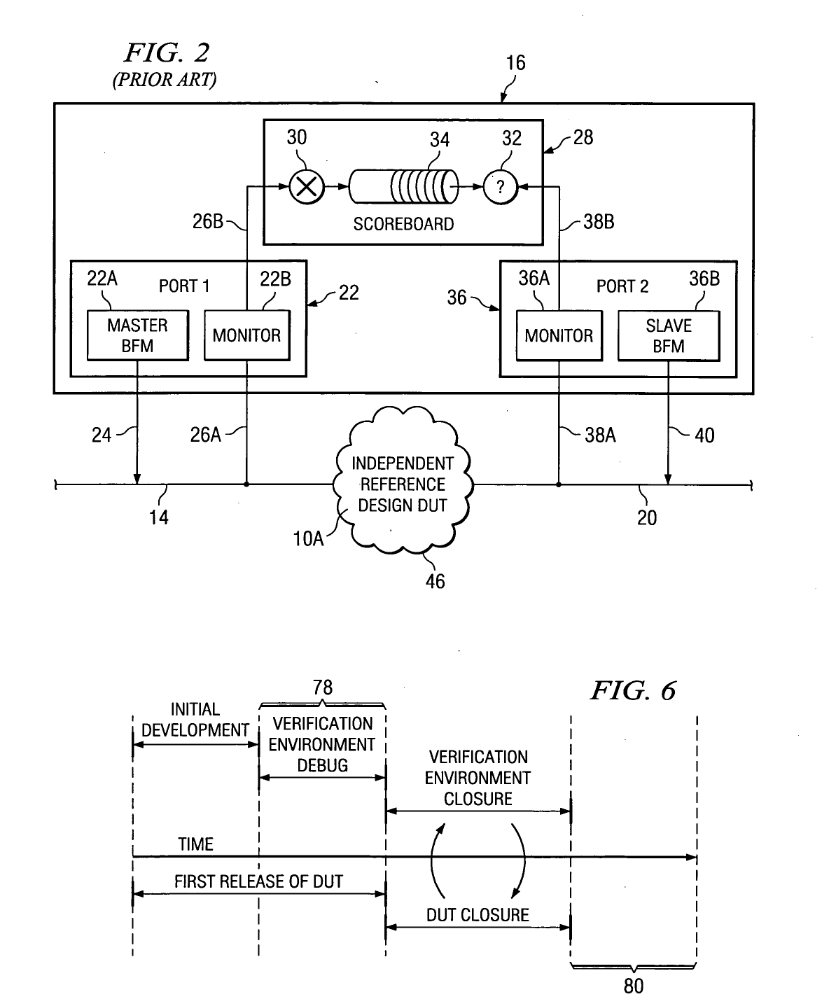

One solution is illustrated in FIG. 2. As shown, the verification circuitry 16 is the same as the circuitry shown in FIG. 12, however, instead of waiting for a first release of the device (or DUT) an Independent Reference Design is used. The independent reference design DUT 10a is typically written in the computer language “C”, which, as will be appreciated by those skilled in the art, often creates its own problems. Furthermore, dedicated resources will be required to develop the “Independent Reference Design”, and verifying the reference design is a major effort itself. Thus, this solution simply does not substantially alleviate the problem.

An approach according to the present invention is to construct a virtual component or DUT (Device Under Test) from components of the verification environment circuitry itself. This approach is similar to the Independent Reference Design discussed with respect to FIG. 2 above. One important exception, however, is that most of the components of the virtual DUT are actually the same as components of the verification environment. Because the code is reused and is also required for the verification environment, the overhead is reduced and consequently the over all cost is reduced. Furthermore, using code components of the verification environment means that there is no need to use the RTL (Register Transfer Language) at all during this portion of the development process. Consequently, another source of errors is removed.

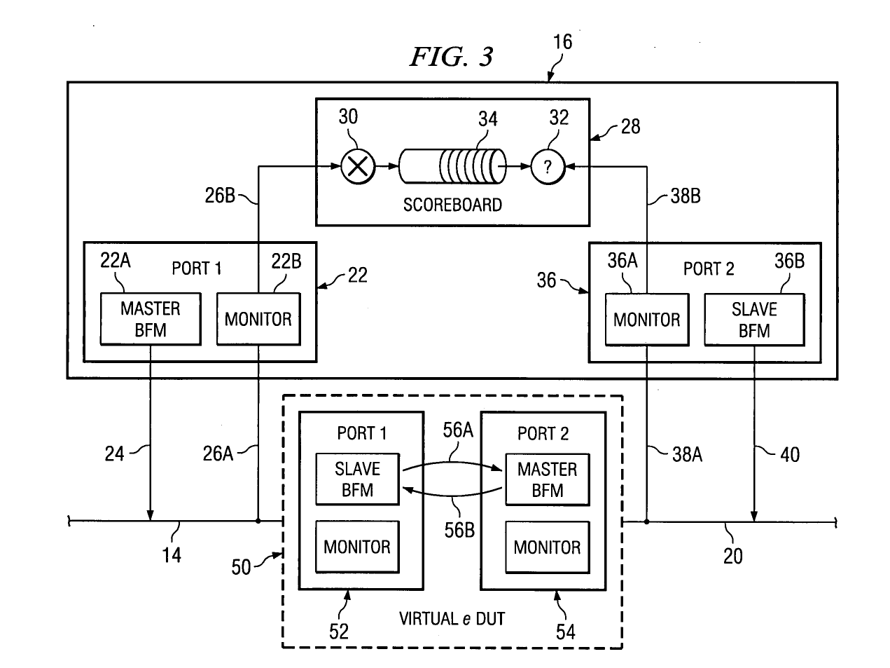

Use of the verification environment components as part of a virtual DUT is illustrated in FIG. 3. As shown in the embodiment of FIG. 3, the verification circuitry 16 is the same as that illustrated and discussed above with respect to FIG. 1A. However, instead of a DUT 10, based on a RTL (Register Transfer Language), the virtual DUT 50 includes circuits 52 that are substantially the same but complimentary to the first port circuitry 22. Likewise, the virtual DUT 50 also includes circuits 54 that are substantially the same, but complimentary, to the second port circuitry 36. More specifically, referring again to the first port circuitry 22 and the slave component of the input portion 12 in DUT 10 of FIG. 1A, it will be recalled that the input portion 12 may also include a “master component” in addition to the slave component. Likewise, the output portion 18 of DUT 10 may also include a “slave component” in addition to the master component. Therefore, according to the present invention, when such a master/slave, slave/master arrangement is available, a second “first port circuit 22” can be used as the input circuitry 52 in the virtual DUT 50 and a second “second port circuit 36” can be used as the output circuitry 54 in virtual DUT 50 as shown in FIG. 3. Thus, these components are written in the same language and can readily connect with each other. Therefore, as mentioned above this aspect of the invention without more eliminates the need for writing or working with code components in RTL.

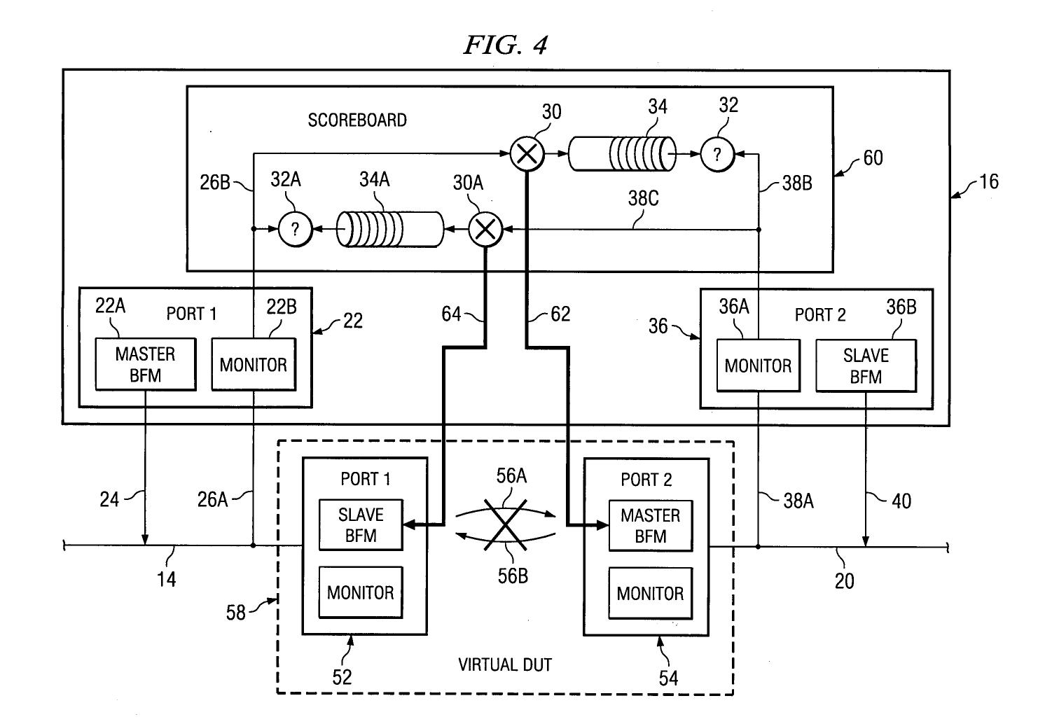

However, to fully implement and achieve the advantages of the virtual DUT 50 discussed above, extra features may be added. Referring now to FIG. 4, there is shown another embodiment of the invention. As shown, the direct connection 56a and 56b between components 52 and 54 in the virtual DUT 58 is eliminated. Further, in addition to the predictor 30, the comparator 32, and the array or register circuits 34, in Scoreboard Circuitry 28 as discussed above with respect to FIG. 1A, the “Scoreboard” Circuitry 60 according to this embodiment of the invention as shown in FIG. 4 includes a second predictor 30a, a second comparator 32a, and second register or array circuits 34a. Other components illustrated in the embodiment of FIG. 4 that are the same and operate the same as the components discussed above with respect to FIG. 1A carry identical reference numbers.

As shown, prediction circuitry or predictor 30 not only provides the predicted values to array or register 34 where they can later be compared to the logic output values on line 20 from virtual DUT 58 when appropriate, but also provides the predicted values to an output component 54 of the virtual DUT 58 through connection line 62. The predicted values from predictor 30 are then used to drive the master component of the output portion 54 to provide outputs on line 20 of the virtual DUT 58 so that the actual output value is the same as the predicted value. Consequently, if comparator 32 does not indicate a match of the predicted values and the actual output from the virtual DUT 58, there is a problem somewhere in the verification environment circuitry between the output line 20 and the predictor 30 in the “Scoreboard” Circuitry 60.

Similarly, the second predictor 30a receives a signal from line 38c indicative of the logic output on line 20 as determined by monitor 36a. Predictor 30a determines or calculates from the signal received on line 38c what logic input(s) on lines 14 were required to be provided to the input component 52 of the virtual DUT 58 to in turn provide the logic output on line 20. This value is provided to array or register 34a to be stored for later use by comparator 32a. As shown, comparator 32a also receives the same signal as provided to the first predictor 30. Therefore, if the circuitry is wired correctly, the signal on line 26b will represent the logic input provided on the input lines 14 to circuitry 52 of virtual DUT 58. Therefore, comparator 32a should see a match of the signal on line 26b with the signal from predictor 30a, and as stored on register or array 34a. If comparator 32a does not indicate a match, there is a problem in the input receiving circuit 52 or the verification environment circuitry between the input lines 14 and the “Scoreboard” Circuitry 60. However, it should also be noted that in addition to providing a signal to register or array 34a, predictor 30a is also connected by line connection 64 to circuitry 52 of the virtual DUT 58. The signal provided by connection line 64 drives the response or slave component of circuitry 52 to ensure the proper response value is monitored by monitor 22b of the first port circuitry 22. Thus, if there is an improper reading, the problem can be isolated more precisely in the verification environment. Therefore, it is seen that the new and inventive circuitry arrangement discussed with respect to FIG. 4 provides a faster and more dependable technique for testing the environment verification circuitry. However, it is important to also understand that a verification that the circuitry provides a correct logic output in response to a selected logic input does not also verify that the circuitry will provide an improper or incorrect logic output if an improper or incorrect logic input is provided on lines 14 to the virtual DUT circuitry 58.

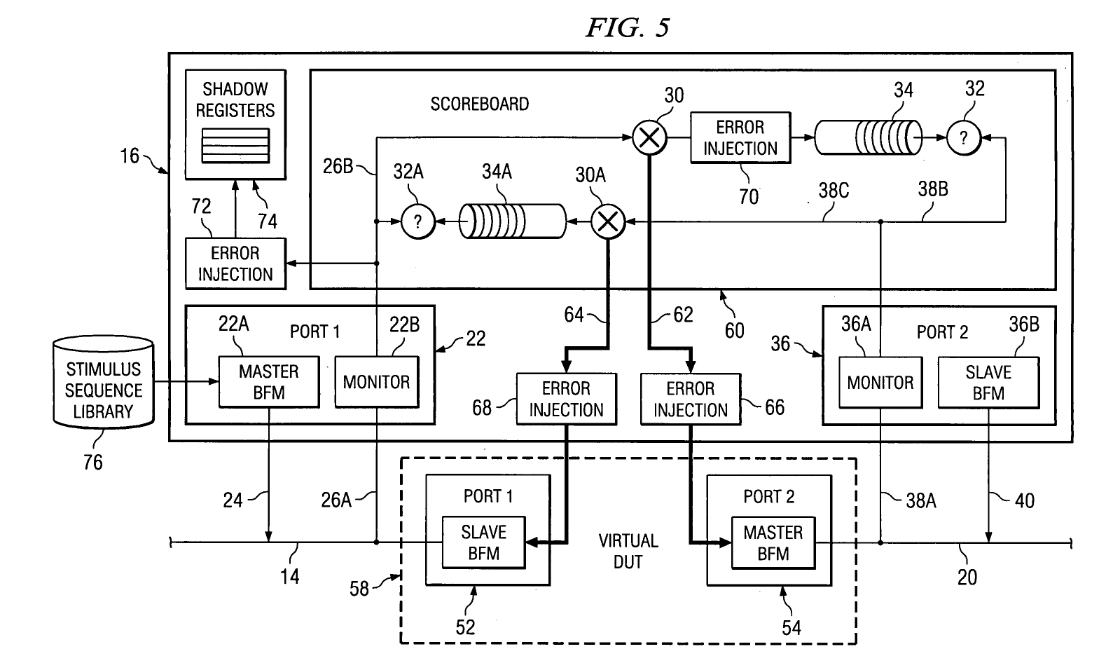

Therefore, referring now to FIG. 5, there is illustrated another embodiment of the present invention. FIG. 5 is similar to the embodiment of FIG. 4, except that it further includes various circuits for injection errors into the system. Thus, known errors and/or bugs can be injected into the system to ascertain that “incorrect logic inputs” don't result in “correct logic outputs”. Those components of FIG. 5 that are the same and operate the same as the components of FIG. 4 carry the same reference numbers. Therefore, in the embodiment illustrated in FIG. 5 there is also included a first error injection circuit 66 connected in driver lines 62 between the logic output portion 54 of virtual DUT 58 and predictor 30. It will be recalled that as shown in FIG. 4, this line is used to drive the logic output on lines 20 to be the same as the logic outputs predicted by predictor circuit 30 in the Scoreboard 60. There is a similar error injection circuitry 68 connected by drive lines 64 between the logic input portion 52 of DUT 58 and the second predictor 30a of the Scoreboard Circuitry. Errors injected by circuit 66 and 68 allow the detection of corrupted input and output paths, protocol errors, test checker errors, and “Scoreboard” circuit errors. The illustrated embodiment also includes an error injection circuitry 70 between predictor 30 and register or array 34. Error injection circuit 70 provides means for testing the operation of the “Scoreboard” circuitry 60 by corrupting the input to register or array 34. There may also be included an error injection circuit 72 to a shadow register 74 that allows verification of the protocol checker and additional checking or verification of the Scoreboard. The embodiment also includes the “Stimulus Sequence Library” 76 for providing the millions and millions of the logic inputs to the virtual DUT 58.

Referring now to FIG. 6, there is shown a timeline diagram similar to that of FIG. 1B. As shown, unlike FIG. 1B, the timeline of FIG. 6 does not include the time period 42 where the verification engineer must wait for an operational DUT. Neither does the timeline of FIG. 6 include the time period 44 where the circuit design engineer must wait until the testing environment has been verified. That is, debugging of the verification environment indicated by time period 78 can take place along with the initial develop of the new logic device (DUT) and ideally can be completed by the time of the first release of the DUT. This means a scheduled time saving 80 as indicated by FIG. 6.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, means, methods and steps described in the specification. As one of ordinary skill in the art will readily appreciate from the disclosure of the present invention, process, machine, means, methods, or steps, presently existing or later to be developed, that perform substantially the same function or achieve substantially the same result as the corresponding embodiments described herein may be utilized according to the present invention. Accordingly, the appended claims are intended to include within their scope such process, machine, means, methods, or steps.

1. A method of testing the correct operation of the logic environment associated with a selected device or component comprising the steps of:
providing a virtual device or component representative of said selected device, said virtual device for receiving input logic signals and for providing output logic signals;
generating signals representative of selected logic inputs to said selected device and providing said logic inputs to said virtual device;
monitoring selected logic outputs and said selected logic inputs of said virtual device;
predicting said selected logic outputs of said selected device as a function of said selected logic inputs;
driving said selected logic outputs to be the same as said predicted logic outputs; and
comparing said monitor of logic outputs to said predicted logic outputs to determine if they are the same.

2. The method of claim 1 further comprising storing said predicted logic outputs.

3. The method of claim 1 further comprising the steps of:
predicting or determining logic inputs as a function of the monitored logic outputs;
driving said logic inputs to be the same as said predicted or determined logic inputs; and
comparing said monitored logic inputs to said predicted logic outputs to determine if they are the same.

4. The method of claim 3 further comprising the step of storing said predicted logic outputs and said predicted or determined logic inputs.

5. The method of claim 4 further comprising the step of injecting at least one selected error into at least one of said logic environment and said virtual device, and determining if said monitored inputs or outputs respond to said at least one selected injected error.

6. The method of claim 5 wherein said step of injecting an error comprises the step of driving a logic output to an incorrect value.

7. The method of claim 5 wherein said step of injecting an error comprises the step of driving a monitored logic input to an incorrect value.

8. The method of claim 5 wherein said step of injecting an error comprises the step of storing an improper value as said predicted logic output.

9. The method of claim 1 wherein said virtual device includes at least some of the same components used in the verification environment.

10. The method of claim 1 wherein said steps are implemented in software.

11. An arrangement for testing the correct operation of a logic environment for a selected logic device comprising:
a virtual device representative of said selected device, said virtual device for receiving input logic signals and for providing output logic signals;
signals representative of selected logic inputs received by said selected device connected to said virtual device;
circuitry for monitoring selected logic outputs and said selected logic inputs of said virtual device;
circuitry for predicting said selected logic outputs of said selected device as a function of said selected logic inputs;
circuitry for driving said selected logic outputs to be the same as said predicted logict outputs; and
a comparator for comparing said monitored logic outputs to said predicted logic outputs to determine if they are the same.

12. The arrangement of claim 11 further comprising a memory device for storing said predicted logic outputs.

13. The arrangement of claim 11 further comprising:
circuitry for predicting or determining said received logic input as a function of the monitored logic output;
circuitry for driving said logic inputs to be the same as said predicted or determined logic inputs; and
comparing said monitored logic input to said predicted logic outputs to determine if they are the same.

14. The arrangement of claim 13 further comprising memory devices or registers for storing said predicted logic outputs and said predicted or determined logic inputs.

15. The arrangement of claim 14 further comprising circuitry for injecting at least one selected error into said logic environment and said virtual device to determine if said monitored inputs and outputs respond to said at least one selected injected error.

16. The arrangement of claim 15 wherein said circuitry for injecting at least one error drivers said logic output to an incorrect value.

17. The arrangement of claim 15 wherein said circuitry for injecting at least one error drives said monitored logic input to an incorrect value.

18. The arrangement of claim 15 wherein said circuitry for injecting at least one error stores an improper value as said predicted logic output.

19. The arrangement of claim 11 wherein said virtual device includes at least some of the components comprising said verification environment

20. The arrangement of claim 11 wherein said elements are implemented in software.
